(19) United States
(12) Patent Application Publication
(10) Pub. No.: US 2009/0056514 A1
(43) Pub. Date: Mar. 5, 2009

(54) Quick release device for a saw blade guard assembly of a circular saw

(75) Inventor: Jung-Huo Chen, Taichung (TW)

Correspondence Address: BACON & THOMAS, PLLC, 625 SLATERS LANE, FOURTH FLOOR, ALEXANDRIA, VA, 22314-1176, US

(73) Assignee: Rexon Industrial Corp., Ltd., Taichung (TW)

(21) Appl. No.: 12/230,046

(22) Filed: Aug. 22, 2008

(30) Foreign Application Priority Data
Aug. 31, 2007 (TW) 096132583

(51) Int. Cl. B27G 19/02; B27G 19/08

(52) U.S. Cl. 83/102.1; 83/478; 83/544; 403/322.4

(57) ABSTRACT

A quick release device for use in a saw to secure a guard cover to a spreader of a saw blade guard assembly. The quick release device includes a mounting block, which has a mounting groove for receiving the spreader, a pivot member pivotally mounted in the mounting block and having a non-circular shoulder received in a receiving portion of a notch on the spreader, and a lever coupled to the pivot member for rotating the pivot member to cause the shoulder of the pivot member to be locked in the receiving portion of the notch or to be movable out of the notch.

### BACKGROUND

1. Field of the Invention

The present invention relates to a table saw and more particularly, to a quick release device for use with a saw blade guard in a circular saw.

2. Description of the Related Art

Each of U.S. Patent Application Publication Nos. 2007/0113714 and 2007/0113715 disclose a module guard system for use in a power sawing machine, and the module guard system includes a spreader and a quick release device.

According to the '714 publication, the quick release device includes a support member, a locking block, and two bolts. The locking block has a mounting groove formed at a bottom side thereof for holding the spreader. The two bolts are respectively inserted through the support member and the locking block to combine the support member and the locking block together. One of the two bolts is inserted through a locating hole of the spreader to secure the spreader to the mounting groove of the locking block. When the user intends to remove the quick release device from the spreader, the user must push the locking block leftwards to force the bolt to disengage from the locating hole of the spreader, thus removing the quick release device from the spreader.

According to the '715 publication, a control member is provided for pulling by the user to move the bolt away from the locating hole of the spreader for allowing removal of the quick release device from the spreader.

The aforesaid two designs allow mounting or dismounting the quick release device on or from the spreader. However, both of the two designs are structurally complicated. Further, mounting and dismounting of the two designs requires additional time, thus causing operational inconvenience to the user.

### SUMMARY

The present disclosure provides a quick release device for a saw blade guard assembly of a circular saw, which allows quick mounting of a pawl or saw blade guard on a spreader and quick dismounting of the pawl or saw blade guard from the spreader, which has a simple structure and avoids the issues discussed above.

The quick release device is configured for use with a saw blade guard assembly in a saw, comprising a mounting block, a pivot member, and a lever. The saw blade guard assembly of the saw comprises a spreader. The spreader has a notch. The notch has a connection portion and a receiving portion at an inner side of the connection portion. The connection portion has a width smaller than the width of the receiving portion. The mounting block comprises two substantially parallel sidewalls, a mounting groove defined between the parallel sidewalls for receiving the spreader, and two through holes respectively cut through the sidewalls in communication with the mounting groove. The pivot member is inserted through the through holes of the mounting block and includes a shoulder attachable to the receiving portion of the notch of the spreader. The cross section of the shoulder has a major axis and a minor axis. The major axis has a length greater than the width of the connection portion of the notch of the spreader. The minor axis has a length smaller than the width of the connection portion of the notch of the spreader. The lever is coupled to the pivot member and is operable to rotate the pivot member between a first position where the shoulder of the pivot member is locked to the notch and a second position where the shoulder of the pivot member is movable with the pivot member out of the notch through the connection portion.

### BRIEF DESCRIPTION OF THE DRAWINGS

FIG. 1 is a schematic front view of an exemplary embodiment of the present disclosure.

FIG. 2 is an exploded view of the exemplary embodiment of the present disclosure.

FIG. 3 is a schematic side view of the exemplary embodiment of the present disclosure.

FIG. 4 is a sectional view taken along line 4-4 of FIG. 3.

FIG. 5 is an enlarged view of a part of FIG. 4, showing positioning of the pivot member in the respective notch of the spreader.

FIG. 6 is similar to FIG. 3, showing the unlocked status of the quick release device.

FIG. 7 is a sectional view taken along line 7-7 of FIG. 6.

### DETAILED DESCRIPTION OF THE EMBODIMENT

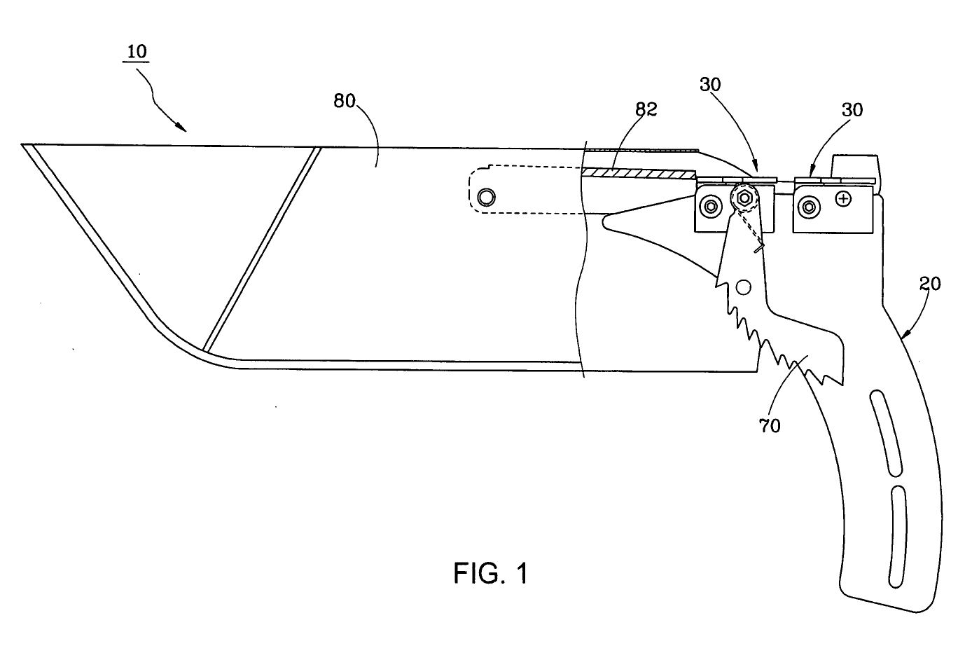

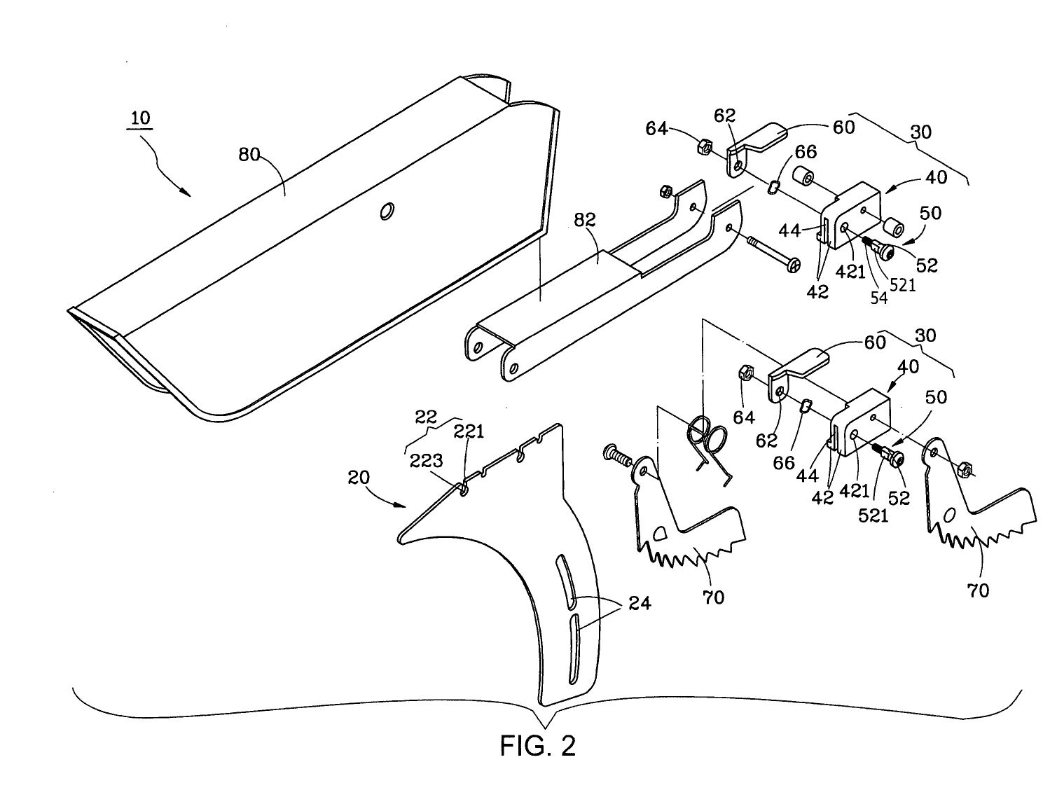

Referring to FIGS. 1 and 2, a saw blade guard assembly 10 for a circular saw in accordance with the present disclosure is shown comprising a spreader 20, two quick release devices 30, an antikickback device 70 and a guard cover 80.

The spreader 20 has two notches 22 and two elongated slots 24. Each notch 22 has a connection portion 221, and a receiving portion 223 positioned at the inner side of the connection portion 221. The connection portion 221 extends in the vertical direction, having a width L1 that is smaller than the width L0 of the receiving portion 223. The two elongated slots 24 are formed on the spreader at different elevations for the mounting of connection means (not shown) to connect the spreader 20 to a saw blade holder (not shown) so that the spreader 20 can be moved with the saw blade up and down to prevent accidental jamming of the cut part of the workpiece (not shown) during the cutting action of the saw blade.

Referring to FIGS. 2 through 4, each quick release device 30 comprises a mounting block 40, a pivot member 50, and a lever 60.

The mounting block 40 comprises two sidewalls 42, a mounting groove 44 defined between the sidewalls 42 for receiving the spreader 20, and two through holes 421 respectively transversely cut through the sidewalls 42 in communication with the mounting groove 44.

The pivot member 50 is inserted through the through holes 421 of the mounting block 40, and includes a shoulder 52 inserted into the receiving portion 223 of one notch 22 of the spreader 20 and a threaded shank 54 axially extending from one side of the shoulder 52.

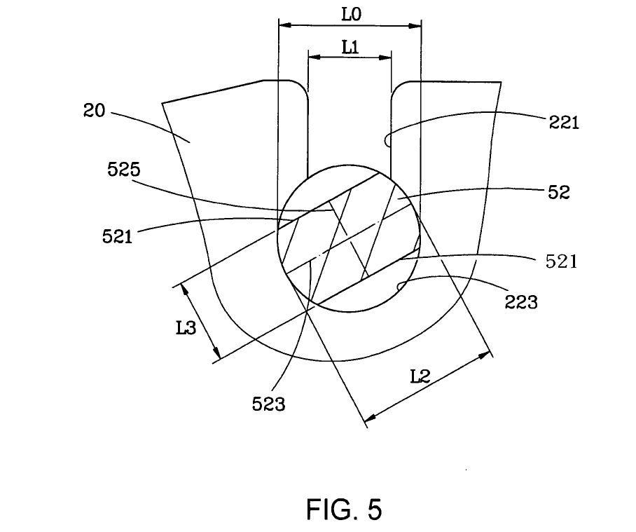

As shown in FIG. 5, the shoulder 52 has two substantially planar surfaces 521 arranged substantially in parallel so that the cross section of the shoulder 52 has a major axis 523 and a minor axis 525. The length L2 of the major axis 523 is greater than the width L1 of the connection portion 221 of each notch 22 of the spreader 20. The length L3 of the minor axis 525 is smaller than the width L1 of the connection portion 221 of each notch 22 of the spreader 20.

The lever 60 has a coupling hole 62 coupled to the pivot member 50 for allowing rotation of the pivot member 50 with the lever 60.

Each quick release device 30 further comprises a nut 64 and a wave spring washer 66. The nut 64 is threaded onto the threaded shank 54 of the pivot member 50 and contacts the side of the lever 60 opposite to the mounting block 40 to prevent disconnection of the lever 60 from the pivot member 50. The wave spring washer 66 is arranged on the pivot member 50 between the mounting block 40 and the lever 60 to prevent loosening of the lever 60 after the lever 60 has been set in position.

The antikickback device 70 is pivotally connected to the mounting block 40 of one quick release device 30 to prevent sudden backward displacement of the workpiece during cutting.

The guard cover 80 is pivotally coupled to the mounting block 40 of the other quick release device 30 by means of a link 82. Therefore, the guard cover 80 can be adjusted relative to the spreader 20 to stop cutting chips from scattering and to guard the saw blade.

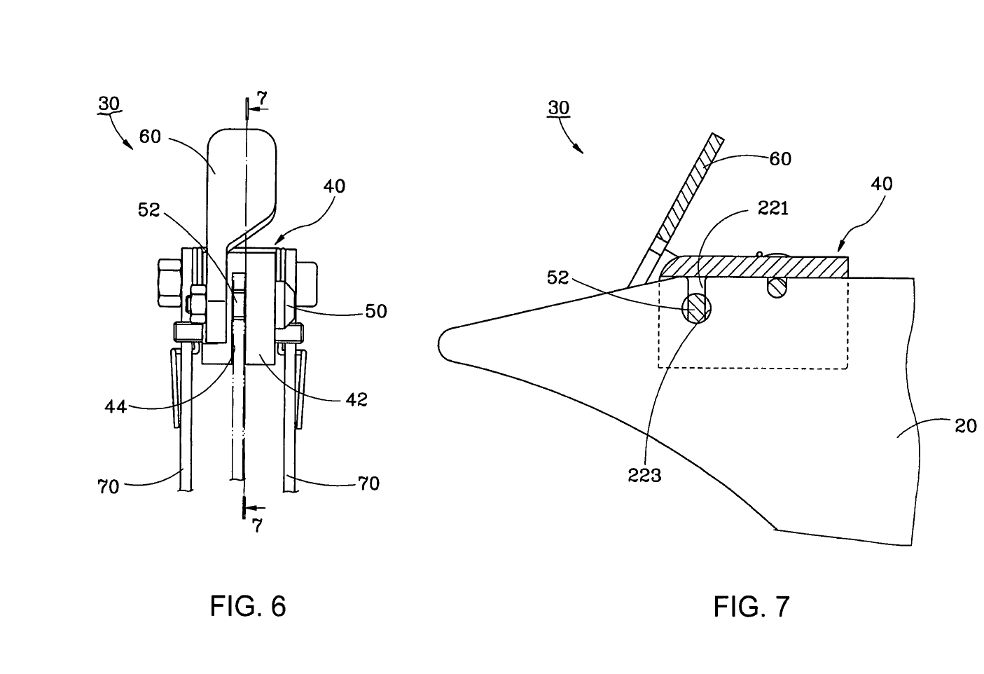

When the user wishes to remove the antikickback device 70 and the guard cover 80 from the spreader 20, the lever 60 of each respective quick release device 30 is rotated so that the minor axis 525 of the shoulder 52 of each pivot member 50 is parallel to the horizontal plane as shown in FIGS. 6 and 7. At this time, the user can lift the antikickback device 70 and the quick release devices 30 to move the shoulders 52 of the pivot members 50 through the connection portions 221 of the notches 22 and to further disconnect the quick release devices 30 from the spreader 20, for allowing dismounting of the antikickback device 70.

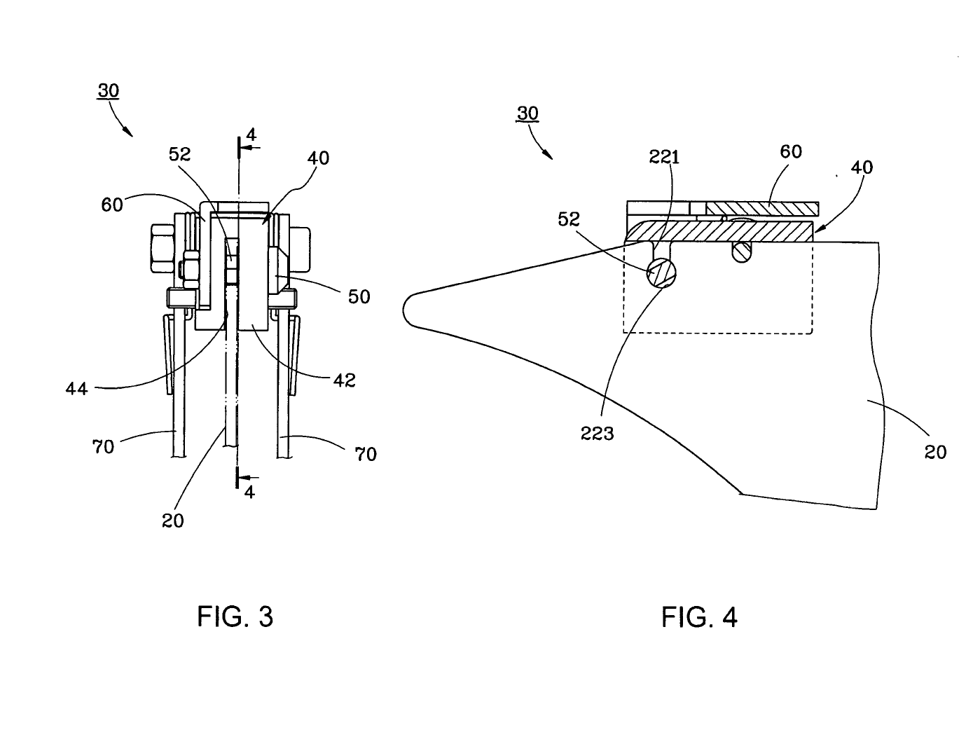

When it is desired to install the antikickback device 70 again, the lever 60 of each respective quick release device 30 is rotated so that the minor axis 525 of the shoulder 52 of each pivot member 50 is parallel to a horizontal plane. The shoulders 52 of the pivot members 50 are then inserted through the connection portions 221 of the notches 22 into the respective receiving portions 223. The lever 60 of each respective quick release device 30 is then rotated so that the minor axis 525 of the shoulder 52 of each pivot member 50 is turned to a position that is not in parallel to the horizontal plane (see FIGS. 3 and 4), thus locking the antikickback device 70 to the spreader 20.

Because the quick release devices 30 for the saw blade guard assembly 10 for use with a circular saw are simply comprised of a limited number of parts including the mounting blocks 40 and the pivot members 50, they are of a simple structural design. By means of rotating the pivot member 50 of each quick release device 30 between two different angular positions, the quick release devices are alternatively set between the locking or unlocking position to allow the antikickback device 70 be locked to or dismounted from the spreader 20, improving the convenience of operation.

The mounting or dismounting of the guard cover 80 is accomplished in the same manner as the mounting or dismounting of the antikickback device 70, therefore no further detailed description in this regard is necessary.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A quick release device configured for use with a saw to secure a guard cover to a spreader of a saw blade guard assembly, said spreader comprising a notch arranged for the mounting of said quick release device, said notch comprising a connection portion and a receiving portion positioned at an inner side of said connection portion, said connection portion having a width smaller than a width of said receiving portion, the quick release device comprising:
a mounting block having first and second sidewalls, a mounting groove defined between said sidewalls configured for receiving said spreader, and first and second axially aligned through holes respectively defined through said first and second sidewalls in communication with said mounting groove; and
a pivot member inserted through said through holes having a shoulder configured to be received in said receiving portion of said notch of said spreader, a cross section of said shoulder having a major axis and a minor axis, said major axis having a length greater than the width of said connection portion of said notch of said spreader, said minor axis having a length smaller than the width of said connection portion of said notch of said spreader.

2. The quick release device according to claim 1, wherein said shoulder has two substantially planar surfaces defined at two opposite sides thereof in a substantially parallel manner.

3. The quick release device according to claim 1, further comprising a lever affixed to said pivot member and arranged for rotating said pivot member in said notch of said spreader.

4. The quick release device according to claim 3, wherein said lever comprises a coupling hole defined therethrough and coupled to said pivot member for allowing rotation of said pivot member with said lever relative to said mounting block.

5. The quick release device according to claim 3, wherein said pivot member comprises a threaded shank; the quick release device further comprises a nut threaded onto said threaded shank of said pivot member and contacting one side of said lever opposite to said mounting block, and a wave spring washer arranged on said pivot member between said mounting block and said lever.

6. The quick release device according to claim 3 wherein said shoulder has two substantially planar surfaces defined at two opposite sides thereof in a substantially parallel manner;
wherein rotation of said lever in a first direction aligns the substantially planar surfaces of said shoulder with said connection portion to allow removal of said shoulder therethrough from said receiving portion; and
wherein rotation of said lever in a second direction misaligns the substantially planar surfaces of said shoulder with said connection portion to retain said shoulder in said receiving portion.

7. A saw blade guard assembly configured for use with a saw, comprising:
a spreader having a notch with a connection portion and a receiving portion positioned at an inner side of said connection portion, said connection portion having a width smaller than a width of said receiving portion;
a quick release device having;
a mounting block including first and second sidewalls, a mounting groove defined between said sidewalls configured for receiving said spreader, and first and second axially aligned through holes respectively defined through said first and second sidewalls in communication with said mounting groove; and
a pivot member inserted through said through holes having a shoulder configured to be received in said receiving portion of said notch of said spreader, a cross section of said shoulder having a major axis and a minor axis, said major axis having a length greater than the width of said connection portion of said notch of said spreader, said minor axis having a length smaller than the width of said connection portion of said notch of said spreader.

8. The saw blade guard assembly for use with a saw according to claim 7, wherein said shoulder has two substantially planar surfaces defined at two opposite sides thereof in a substantially parallel manner.

9. The saw blade guard assembly for use with a saw according to claim 7, further comprising a lever affixed to said pivot member and arranged for rotating said pivot member in said notch of said spreader.

10. The saw blade guard assembly for use with a saw according to claim 9, wherein said lever comprises a coupling hole defined therethrough and coupled to said pivot member for allowing rotation of said pivot member with said lever relative to said mounting block.

11. The saw blade guard assembly for use with a saw according to claim 9, wherein said pivot member comprises a threaded shank; the quick release device further comprises a nut threaded onto said threaded shank of said pivot member and contacting one side of said lever opposite to said mounting block, and a wave spring washer arranged on said pivot member between said mounting block and said lever.

12. The saw blade guard assembly for use with a saw according to claim 9 wherein said shoulder has two substantially planar surfaces defined at two opposite sides thereof in a substantially parallel manner;
wherein rotation of said lever in a first direction aligns the substantially planar surfaces of said shoulder with said connection portion to allow removal of said shoulder therethrough from said receiving portion; and
wherein rotation of said lever in a second direction misaligns the substantially planar surfaces of said shoulder with said connection portion to retain said shoulder in said receiving portion.

13. The saw blade guard assembly for use with a saw according to claim 7, further comprising:
a guard cover pivotally connected to said mounting block.

14. The saw blade guard assembly for use with a saw according to claim 7, further comprising:
an antikickback device pivotally connected to said mounting block.

15. A saw blade guard assembly for use with a saw, comprising:
a spreader having first and second notches, each notch having a connection portion and a receiving portion positioned at an inner side of said connection portion, said connection portion having a width smaller than a width of said receiving portion;
first and second quick release devices, each having;
a mounting block including first and second sidewalls, a mounting groove defined between said sidewalls configured for receiving said spreader, and first and second axially aligned through holes respectively defined through said first and second sidewalls in communication with said mounting groove;
a pivot member inserted through said through holes having a shoulder configured to be received in said receiving portion of said notch of said spreader, a cross section of said shoulder having a major axis and a minor axis, said major axis having a length greater than the width of said connection portion of said notch of said spreader, said minor axis having a length smaller than the width of said connection portion of said notch of said spreader;
a guard cover pivotally connected to the first said mounting block; and
an antikickback device pivotally connected to the second said mounting block.

16. The saw blade guard assembly for use with a saw according to claim 15, wherein each said shoulder has two substantially planar surfaces defined at two opposite sides thereof in a substantially parallel manner.

17. The saw blade guard assembly for use with a saw according to claim 15, further comprising first and second levers respectively affixed to said pivot members and arranged for rotating said respective pivot members in said respective notches of said spreader.

18. The saw blade guard assembly for use with a saw according to claim 17, wherein each said lever comprises a coupling hole defined therethrough and respectively coupled to said pivot members for allowing rotation of said pivot members with said levers relative to said respective mounting blocks.

19. The saw blade guard assembly for use with a saw according to claim 17, wherein each said pivot member comprises a threaded shank; each of the quick release devices further comprises a nut threaded onto said threaded shank of said respective pivot member and contacting one side of said respective lever opposite to said respective mounting block, and a wave spring washer arranged on said respective pivot member between said mounting block and said lever.

20. The saw blade guard assembly for use with a saw according to claim 17 wherein each said shoulder has two substantially planar surfaces defined at two opposite sides thereof in a substantially parallel manner;
wherein rotation of said respective lever in a first direction aligns the substantially planar surfaces of said shoulder with said respective connection portion to allow removal of said shoulder therethrough from said respective receiving portion; and
wherein rotation of said respective lever in a second direction misaligns the substantially planar surfaces of said shoulder with said respective connection portion to retain said shoulder in said respective receiving portion.
